(19) United States
(12) Patent Application Publication
(10) Pub. No.: US 2008/0104851 A1
(43) Pub. Date: May 8, 2008

(54) Pocket letteropener

(76) Inventor: Dwight David Roberts, Scottsdale, AZ (US)

Correspondence Address: GALLAGHER & KENNEDY, P. A., 2575 E. CAMELBACK RD. #1100, PHOENIX, AZ, 85016, US

(21) Appl. No.: 11/975,187

(22) Filed: Oct. 17, 2007

Related U.S. Application Data
(60) Provisional application No. 60/852,912, filed on Oct. 17, 2006.

(51) Int. Cl. B26B 29/06; B26B 1/02

(52) U.S. Cl. 30/289; 30/155

(57) ABSTRACT

There is provided a portable letter opener that is capable of transitioning between an open and a closed position. The letter opener includes a first housing section, a second housing section, a blade, and a pin forming a pivot hinge so that the first housing section and second housing section can move between the open and closed positions. The first housing section defines a slot such that the blade is at least partially positioned within the slot of the first housing section when the portable letter opener is in the closed position. The first housing section may also define an aperture for connecting with a key chain. Both the first housing section and the second housing section may define a pair of tab with a hole therein for receiving the pin. The blade, connected to the second housing section, is at least partially exposed when the portable letter opener is in the open position, and the blade has a sharpened edge capable of slicing open a sealed envelope flap. The first housing section and second housing section may have complementary stop surfaces and rest surfaces whereby contact between the stop surface and rest surface limit movement of the letter opener past the open position. Similarly, the first and housing section have complementary surfaces which come into contact when the letter opener is closed. The blade is preferably positioned well within the opening of the letter opener for safety reasons and is set at a slant for easily slicing open envelopes.

### CROSS REFERENCE TO RELATED APPLICATIONS

This application claims priority from the provisional patent application Ser. No. 60/852,912 filed Oct. 17, 2006 in the name of Dwight David Roberts entitled “Pocket Letter Opener” and incorporated herein by reference.

### FIELD OF THE INVENTION

This invention relates to a letter opener and more particularly to a compact safety letter opener that opens and closes.

### BACKGROUND

Traditional letter openers are a common implement present in most business and home offices. Such a traditional letter opener is typically an elongate, knife-like implement having a lengthy blade portion which often has a somewhat dull pointed end remote from an opposite handle end. The letter opener is designed such that the thin blade portion can slip behind the sealed flap of an envelope. Such letter openers are not readily carried on one's person in a pocket, or in a hand bag. Indeed carrying such a traditional letter opener on one's person is hazardous and ill-advised insofar as tripping or stumbling could cause personal injury if the letter opener is then forced against the carrier's body. Consequently traditional letter openers are not seen as portable devices and typically remain in the office.

Nevertheless, there are times when a person, who is away from an office environment, would like to have access to a letter opener. For example, many individuals are familiar with the practice of using a substitute implement, such as a key, a pencil, or even a finger, to open an envelope. This can happen when the individual is in a hurry to open an envelope. It can also happen when an individual needs to open an envelope but is not in the office, such as in a post office facility. However, the use of a substitute implement is often less than satisfactory. For example the contents of the envelope can be damaged or defaced by using a key to open the envelope. Important information recorded on the letter inside the envelope can be lost or erased if the letter is not properly opened.

Hence there exists a need for a portable letter opener. It would be desired to provide a letter opener that could be safely carried and transported on an individual's person, such as in a pocket or handbag. It would further be desired to provide a portable letter opener that quickly and efficiently opens envelopes without damage to letters or contents of the envelope. It is further desired that a portable letter opener be safely transportable with minimal risk of personal injury to the individual. The present invention addresses one or more of these needs.

### SUMMARY OF THE INVENTION

In accordance with the present invention, a small letter opener has a sharp blade. The blade is retained in one section of a two-piece housing. The two pieces of the housing are joined at a hinge. When the two sections of the housing are brought together to close the housing, the blade is not exposed. The two sections of the housing pivot away from one another to open the housing, but only slightly. Only a narrow opening between the pivoted-apart housing sections occurs when the housing is opened. The sharp blade is supported on the one section of the housing rearward toward the pivotal connection of the two housing sections. Preferably the slight opening that occurs is such that even a small child cannot insert a finger sufficiently to reach the blade. The blade extends out of the one housing section supporting the blade. Its sharp edge runs across the slight opening slanting back from the mouth of the slight opening, but well back away from that mouth. When the two housing sections are pivoted together, closing the slight opening and the sharp edge of the blade is received in a slot in the second of the housing sections. The tip of the one, blade-supporting housing section is tapered to a dully pointed end that can be inserted between the flap and the body of a sealed envelope of the kind in which most letters, bills and the like are mailed. With the tip of the one blade-supporting housing section thus inserted, the letter opener is moved along the top of the envelope until the blade engages the envelope and cuts open the envelope along its top.

In one preferred embodiment, a spring, which can be a slender strip of plastic or metal, biases the housing closed so that with a slight urging of the housing parts they will move toward one another and close.

The housing of the letter opener is preferably of a molded plastic. The second section of housing that does not support the blade can be molded sufficiently wide to carry a company or other organization's logo, trademark, trade name or slogan. A hole molded in the housing, preferably in the larger second housing section, can receive a key chain, fob or key ring.

### BRIEF DESCRIPTION OF THE DRAWINGS

FIG. 1 is a perspective view of a letter opener in accordance with the present invention;

FIG. 2 is a perspective view of the opener of FIG. 1, and shows its housing open;

FIG. 3 is a side elevation view of a first, blade-supporting section of a housing of the letter opener of FIGS. 1 and 2;

FIG. 4 is a smaller scale perspective view of the housing section of FIG. 3 without its blade;

FIG. 5 is a smaller scale side elevation view of a second housing section of the letter opener of FIGS. 1 and 2;

FIG. 6 is a perspective view of the second housing section of FIG. 5;

FIG. 7 is a back elevation view of the housing section of FIGS. 5 and 6;

FIG. 8 is a cross-section view of the housing section of FIGS. 5-7, along the line A-A of FIG. 7;

FIG. 9 is an enlarged fragmentary view partly in section, of an alternate embodiment, spring biasing arrangement for biasing the letter opener opened and closed;

FIG. 10 is a side view of a further embodiment of a letter opener in the open position, according to a further embodiment of the present invention;

FIG. 11 is a side view of a further embodiment of a letter opener in the closed position, according to a further embodiment of the present invention;

FIG. 12 is a perspective view of a further embodiment of a letter opener in the open position, according to a further embodiment of the present invention; and

FIG. 13 is a perspective view of a further embodiment of a letter opener in the closed position, according to a further embodiment of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings.

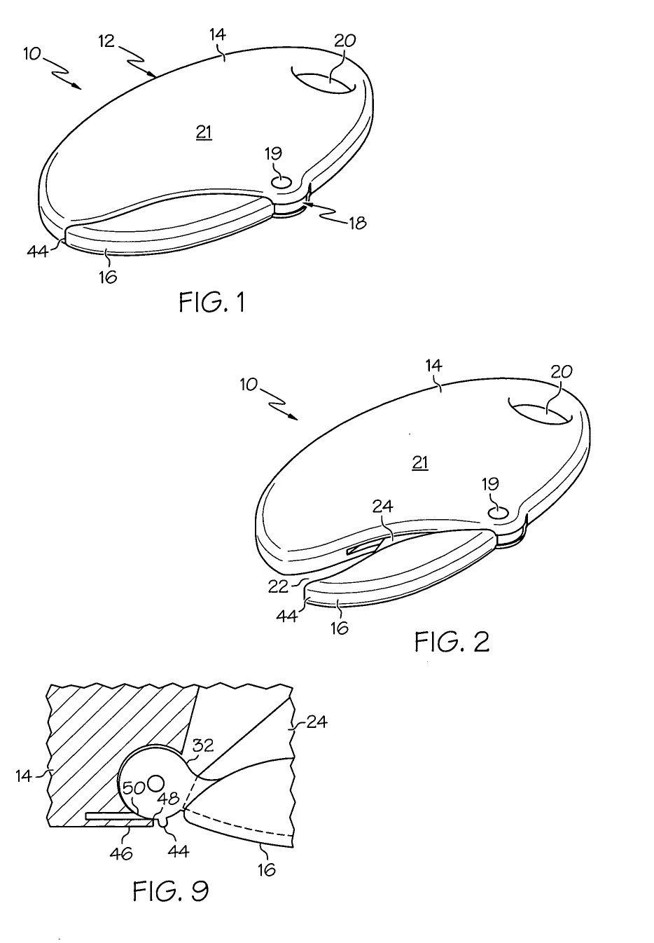

Turning to FIG. 1, a letter opener 10 of the present invention includes a housing 12 that has a first section 14 and a second section 16. The two sections are pivotally connected at a hinge 18 that includes a pin 19. As shown in FIG. 1, the letter opener housing 12 is closed.

Preferably the housing sections 14 and 16 are of molded plastic. A hole 20 may be molded into the second housing section 14 to receive a key chain, fob or key ring. In the preferred embodiment shown, the letter opener is small, measuring in one exemplary embodiment only about 2¼ inches long by about 1¼ inches wide, but of course the opener could be made much larger or even smaller. In the preferred embodiment shown the opener is thin, less than ¼ inch thick. In the preferred embodiment shown, then the letter opener fits easily into a pocket or hand bag. On each side of the housing section 14 a central field 21 is suitable for a logo, trademark, trade name or slogan.

In FIG. 2 the letter opener 10 is shown with its housing 12 open. The two housing sections 14 and 16 are pivoted slightly apart to form a narrow opening 22 revealing a blade 24 that is supported within the opening 22. The blade 24 is positioned well back in the opening 22 away from the mouth 26.

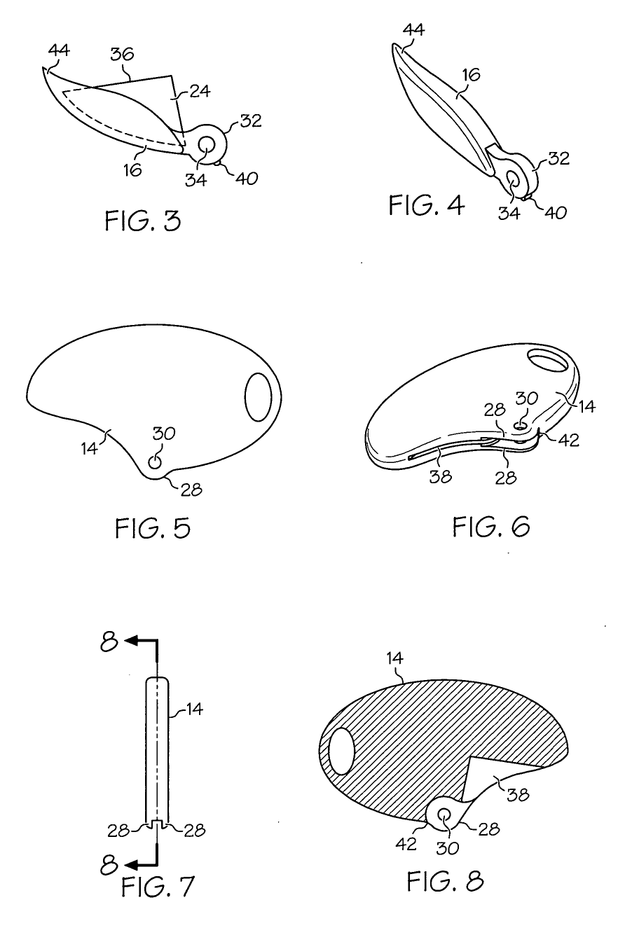

As shown in FIG. 6, the housing section 14 has a pair of tabs 28 each with hole 30 aligned to receive the pin 19 shown in FIGS. 1 and 2. As seen in FIGS. 3 and 4, the housing section 16 has generally circular projection 32 with a central hole 34. The projection 32 fits between the tabs 28 of the housing section 14 with the hole 34 aligned with the holes 30. The pin 19 shown in FIGS. 1 and 2 fits tightly in or may be glued or heat joined within the holes 30, and the hole 34 of the housing section 16 fits the pin 19 slightly more loosely permitting pivoting of the housing section 16 on the pin.

In FIG. 3 the blade 24 can be seen extending into the body of the housing section 16. Its edge 36 may be sharpened, but this is not absolutely necessary particularly if the blade is very thin. In the preferred embodiment shown the blade 24 is about 0.5 millimeters thick and is sharpened somewhat at its edge 36. The blade 24 of the exemplary, preferred embodiment is stainless steel, but may be e.g. aluminum or other than metal sheet or for that matter the blade 24 may be an integral molded, plastic extension of the housing section 16. The stainless steel blade of the illustrated and described preferred, exemplary embodiment is co-molded into the body of the housing section 16.

As seen in FIGS. 6 and 8, a slot 38 is formed in the housing section 14. This slot receives the blade 24 when the housing 12 is closed as in FIG. 1. A stop 40 is formed on the periphery of the projection 40 of the housing section 16 as seen in FIG. 3. The stop is integrally molded on the projection 40 and extends outwardly sufficiently to engage the exterior surface of the housing section 14 at a location 42 (FIGS. 6 and 8) adjacent the location of the projection 32 between the tabs 28. The stop prevents the housing section 16 pivoting beyond the position shown in FIG. 2 to further open the opening 22. The opening 22 is never large enough to allow access to the blade 24 by even the smallest of fingers.

A tip 44 of the housing section 16 is tapered to a blunt point so as to be able to slip into the small space between the flap and the body of a sealed envelope. In use, with the housing section 14 held above the top of the envelope, the tip 44 of the housing section 16 is inserted in the small opening under the envelope flap of a sealed envelope. The opener 10 is then run along the top of the envelope. The sharp edge 36 of the blade 24 extending slant-wise across the opening 22 (FIG. 2) engages the envelope at the envelope top and slices open the top of the envelope.

In FIG. 9 an alternate arrangement uses a thin biasing spring 46 that resiliently engages one of two flats 48 and 50 formed on the projection 32 to bias the housing section 16 in the open and closed positions. In FIG. 9, the stop 44 engages the spring end to prevent the section 16 opening farther. The spring 46 engages the flat 48 and resists, initially, movement of the housing section 16 to the closed position. However, when the housing section is urged towards the closed position, the intersection of the two flats 48 and 50 moves along the spring 46 until the spring's bias is to the closed position to which the section 16 then snaps. It is held there by the spring 46 engaging the flat 50. Hence, the opener 10 remains closed until purposely opened so as not to cut an edge of clothing, a handkerchief or another item in the pocket or hand bag of a user. The spring 46 can be integrally molded with the plastic of the housing section 14 as shown or can be a thin stainless steel or other resilient metal strip carried by the housing section 14.

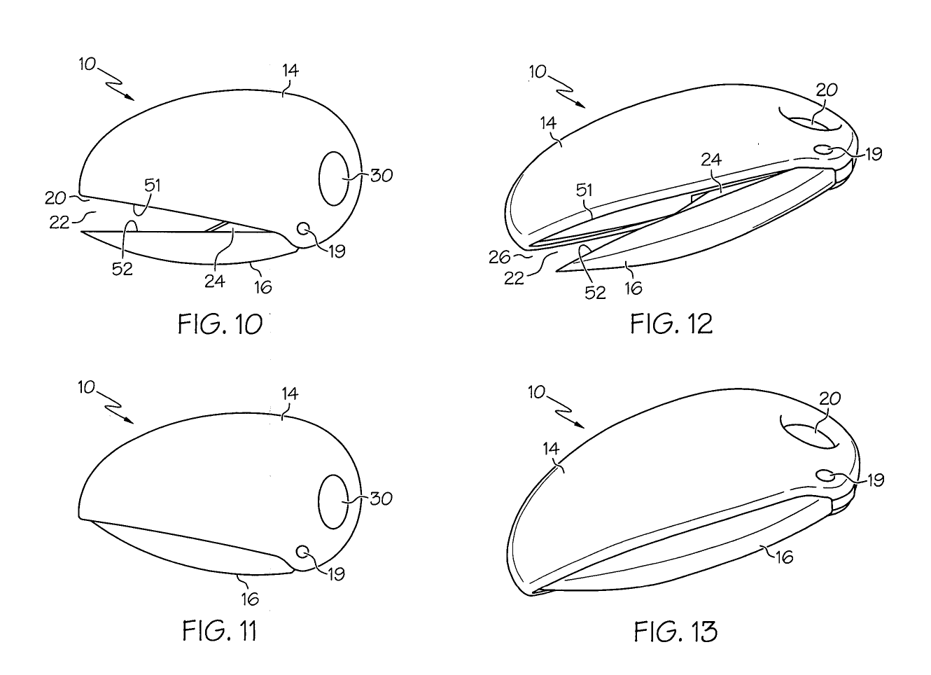

Referring now to FIGS. 10, 11, 12, and 13, there is shown a further embodiment of the pocket letter opener. In this embodiment, first housing section 14 and second housing section 16 have matching surfaces 51, 52. Matching surfaces 51 and 52 make substantial contact when pocket letter opener is in the closed position, and this closure thereby conceals and protects blade 24. In this manner letter opener can be safely transported or carried on an individual's person with minimal risk of injury. In a preferred embodiment, matching surfaces 51 and 52 are substantially flat; however, in other embodiments the surfaces may be curved.

In the illustrated embodiment, where matching surfaces 51 and 52 are substantially flat or planar, this configuration is functional when the letter opener is used to open a letter. A user can open the letter opener so as to expose blade 24. Generally, blade 24 is positioned toward the hinge 18 (or rearwardly) on the letter opener. The bluntly pointed tip 44 of first housing section 14 can be placed between the sealed flap and body of an envelope. Either surface 51 or 52 can then be aligned along the fold created in the envelope by the sealed surface. The upper fold of an envelope, where an envelope is typically sealed, is a generally linear fold and aligns well with surface 51 or 52 of the letter opener. Using this alignment, the user can then sweep letter opener across the envelope's upper fold. In doing so, blade 24 comes into contact with the envelope and cuts therethrough. It is further appreciated that the slanted arrangement of blade 24, relative to surface 52 of second housing section 16, is conducive to this cutting operation.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A safety letter opener having an open and a closed position comprising:
a first housing section;
a second housing section moveably connected to the first housing section so as to move between an open position and a closed position; and
a blade connected to the second housing section, wherein the blade is concealed when the first and second housing are in the closed position and wherein the blade is partially exposed when the first and second housing are in the open position.

2. The safety letter opener according to claim 1 wherein the first and second housing sections define a recess, and further comprising a pin disposed in the recess thereby allowing the second housing section to pivot in relation to the first housing section.

3. The safety letter opener according to claim 2 the blade is disposed proximate to the pin.

4. The safety letter opener according to claim 2 wherein the first housing section defines a contact surface and the second housing section defines a stop surface such that pivotal movement of the second housing section to the open position brings the stop surface into contact with the contact surface.

5. The safety letter opener according to claim 4 wherein the stop surface is in contact with the contact surface when the letter opener is in the open position.

6. The safety letter opener according to claim 1 wherein the first housing section defines a substantially flat first surface and the second housing section defines a substantially flat second surface, and wherein the first surface and second surface come into contact when the safety letter opener is in the closed position.

7. The safety letter opener according to claim 1 wherein first housing section defines a curved first surface and the second housing section defines a curved second surface and wherein the first surface and the second surface are in contact when the safety letter opener is in the closed position.

8. The safety letter opener according to claim 6 wherein the blade is configured so as to be slanted with respect to the second surface.

9. The safety letter opener according to claim 1 wherein the first housing section defines an aperture.

10. A portable letter opener for opening a sealed envelope having a body and a flap sealed against the body, the letter opener capable of transitioning between an open and a closed position, and the letter opener for pocket transportation on a key chain, the letter opener comprising:
a first housing section defining a slot, an aperture, and a first tab with a hole;
a second housing section, pivotally connected to the first housing section, defining a second tab with a hole;
a blade having a sharpened edge capable of slicing open a sealed envelope flap, the blade connected to the second housing section;
a pin disposed within the hole of the first tab and the second tab so as to form a hinge whereby the first housing section and the second housing section may pivotally move between an open and a closed position;
wherein the blade is at least partially exposed when the portable letter opener is in the open position;
wherein the blade is at least partially positioned within the slot of the first housing section when the portable letter opener is in the closed position; and
wherein the first housing section and the second housing section form an opening with a mouth proximate a tip of the first housing section and wherein the blade is positioned away from the mouth and proximate the pin.

11. The portable letter opener according to claim 10 further comprising a stop surface disposed on the second housing section and a rest surface disposed on the first housing section such that the stop surface contacts the rest surface when the letter opener is in a fully open position.

12. The portable letter opener according to claim 10 wherein the first housing section defines an aperture for connecting with a key chain.

13. The portable letter opener according to claim 10 wherein the first housing section and the second housing section comprise a plastic material.

14. The letter opener according to claim 10 wherein the first housing section defines a substantially flat first surface and the second housing section defines a substantially flat second surface, and wherein the first surface and second surface come into contact when the safety letter opener is in the closed position.

15. The letter opener according to claim 15 wherein the blade is slanted with respect to the second surface.

16. The letter opener according to claim 10 wherein first housing section defines a curved first surface and the second housing section defines a curved second surface and wherein the first surface and the second surface are in contact when the safety letter opener is in the closed position.

17. The letter opener according to claim 10 wherein the tip of the first housing section is blunt and thin for sliding between the flap and body of the envelope.

18. A method for opening a sealed envelope with a portable letter opener, the method comprising the steps of:
providing a sealed envelope having a flap sealed against an envelope body whereby the envelope defines a gap between the envelope flap and the envelope body and whereby the envelope defines a fold;
positioning the blunt point tip of a first housing section of the portable letter opener in the gap of the envelope;
moving the tip of the first housing section along the fold so as to bring a blade in contact with the envelope flap; and
further moving the letter opener across the envelope so that the blade slices open the envelope.

19. The method according to claim 18 further comprising the step of first transitioning the letter opener from a closed position to an open position so as to expose the blade.

20. The method according to claim 18 further comprising the step of transitioning the letter opener from an open position to a closed position so as to cover the blade.
